(19) United States
(12) Patent Application Publication
(10) Pub. No.: US 2003/0146942 A1
(43) Pub. Date: Aug. 7, 2003

(54) Medical advice expert

(75) Inventors: Ivar S. Helgason, Kopavogur (IS); Halldor Skulason, Reykjavik (IS); Thorvarour Jon Love, Reykjavik (IS); Julius H. Schopka, Reykjavik (IS)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: deCode Genetics ehf., Reykjavik (IS)

(21) Appl. No.: 10/071,787

(22) Filed: Feb. 7, 2002

(51) Int. Cl. G09G 5/00

(52) U.S. Cl. 345/968

(57) ABSTRACT

A graphical user interface (GUI) presents to a clinician/user coded medical information in at least one logical hierarchy, and accepts selections of the presented information made by the user. An electronic medical record generator records user selections into an electronic medical record. The logical hierarchy may be organized, for example, by physiological system, or by type of examination. The GUI includes an image of a body, from which a user can select a body part for examination, examination method selection controls, and one or more sets of buttons optimized for a touchscreen. Each button has a bulbous portion and a narrower label portion. The bulbous portion is large enough to be easily contacted with the user's finger without the user's finger contacting an adjacent button. The narrow label portion protrudes from the bulbous portion and can contain a text label. The controls can thus be lined up alternately in opposite orientations so that they are tightly stacked. A set of controls/buttons can be for indicating and allowing selection of systems of observation. Another set of buttons can be for indicating and allowing selection of observations. Each of these controls can correspond to a medical coding system code for a medical observation and can contain a descriptive label. The system can further comprise an expert system that suggests tests based on user selections. Suggested tests can be highlighted by the graphical user interface.

### BACKGROUND OF THE INVENTION

Typical of medical practice, a doctor or other clinician examines a patient, jots down a few notes, makes some mental notes. After the examination has been completed, the physician retreats to his office where he dictates his report onto tape from whatever notes he might have written down, and from his memory. At some later time, the tape will be transcribed by another person or a speech-to-text program into a computer text file which becomes part of a medical record.

The physician dictates freely. That is, generally whatever phrase comes to mind as the physician is dictating is what is spoken onto the recording system and eventually becomes part of the record.

Although there are standard medical codes for describing medical observations, such as the Systematized Nomenclature of Medicine, or SNOMED®, these codes are lengthy and unwieldy for the purposes of an examining physician, and are therefore seldom used for such purposes. They are also difficult to find, buried deep within complex data trees.

Thus, because medical records are generally made using free text, i.e., the data is not entered in any standardized way, the data contained therein cannot be used to collect important information. For example, it is not possible to determine how many people have sore throats where the descriptions (choice of words, terms) entered by physicians vary so widely.

### SUMMARY OF THE INVENTION

The present invention is called Medical Advice Expert, or MAX. It is a clinical system intended for use by physicians and their supporting staff. The software facilitates the rapid entry of coded medical information into an electronic medical record system (EMR), doing away with potential errors caused by misunderstanding of the transcriber, or typographical errors, or errors inherent in speech-to-text software.

Using a graphical interface a medical professional can rapidly enter clinical information which is automatically coded using a standard medical coding system such as the Systematized Nomenclature of Medicine, or SNOMED®. The coding process is therefore invisible to the clinician, freeing his time to concentrate on the medical problem at hand.

Because standard codes are utilized, it becomes easy to later use the data for statistical purposes, such as determining how many examined patients had rashes.

MAX is also a clinical decision support system using all data entered by clinical staff, as well as older data available from an EMR system, to suggest relevant examinations, tests and possible differential diagnoses, i.e., a list of likely diseases given a patient's age, medical history, symptoms, etc. This information is used by the system to decide which options are likely to be of interest to the user and draws attention to those options.

MAX draws on information entered into the EMR to automatically create requests for those tests, studies and consultations the clinician decides are necessary. Therefore, the present invention eliminates the need for filling in multiple forms by hand after the patient has been examined, freeing up more of the clinical staffs time.

An embodiment of MAX uses a graphical interface presented on a touchscreen to present information and gather data. This approach makes it possible to enter an entire patient history and examination without using a traditional keyboard. In fact, this system relies heavily on the possibilities offered by using a touchscreen (or similar non-keying/non-typing input mechanism) and would not be efficient in many clinical settings without it. It can, however, be used with any combination of graphical display and input system, including, but not limited to, mouse, keyboard, pen, tablet, etc.

MAX has two main objectives: to aid the physician by simplifying and speeding up the clinical work process and by putting as few obstacles as possible in the physician's way; while at the same time gathering high quality coded (standardized) clinical data.

Accordingly, a medical advice expert system of the present invention includes a graphical user interface that presents to a user coded medical information in at least one logical hierarchy, and that accepts selections of the presented information made by the user. An electronic medical record generator is responsive to the graphical user interface and records user selections into an electronic medical record.

One way of organizing the logical hierarchy is by physiological system. Another is by type of examination. Both organizations may be available in a single embodiment.

The graphical user interface (GUI) can include an image of a body, from which a user can select a body part for examination. The GUI can also include examination method selection controls (or visual buttons), from which the user can select an examination method.

Interactive v. Operational

In addition, the GUI can include at least one set of operational work elements (commonly known as “buttons”) optimized for a touchscreen, where each button has a bulbous portion and a narrower label portion. The bulbous portion is large enough to be easily contacted with the user's finger to select the button without the user's finger contacting an adjacent button. The narrow label portion protrudes from the bulbous portion and can contain a text label indicative of the subject or effect of the button.

The design (above-described shape) of the controls or buttons allows them to be lined up alternately in opposite orientations so that they are tightly stackable in a screen view without loss in ease of use.

One set of controls/buttons can be for indicating and allowing selection of systems of observation. Another set of buttons can be for indicating and allowing selection of observations. Each of these buttons can correspond to a medical coding system code for a medical observation and can contain a descriptive label.

The invention system can further comprise an expert system that suggests tests based on user selections. Suggested tests can be displayed highlighted by the graphical user interface, for example by coloring, underlining, blinking, etc., a button and/or text, or by displaying particular objects such as icons or arrows.

More generally, a patient history and examination support system of the present invention includes (i) a processor, (ii) an input device connected to the processor, (iii) a display connected to the processor, (iv) a graphical user interface presented on the display which assists a user in an examination of a patient and accepts medical data, entered by the user, and that automatically corresponds with a medical coding system code, and (v) storage for storing codes associated with the entered medical data, such that the stored codes are associated with the patient.

The graphical user interface can include (i) an image of a body, from which a user can select a body part for examination; (ii) examination method selection controls, from which the user can select an examination method; (iii) a first set of controls indicating physiological systems of observation to which a selected examination method can be applied; and (iv) a second set of controls based on the selected examination method and a selected physiological system or body part. Each second set control corresponds to a medical coding system code for a medical observation and contains a descriptive label. Additional sets or levels of controls can be used if warranted, allowing selection of codes at finer details.

The body image can be updated based on user selections.

A touch-sensitive screen (“touchscreen”) can be used as both display and input device. The user can select a body part by touching a corresponding part of the body image displayed on the screen.

The user can also select a control by touching the control. Controls therefore can include a bulbous portion large enough to be easily contacted with the user's finger without the finger contacting an adjacent control, and a narrow label portion protruding from the bulbous portion to provide a text label. This feature allows plural controls to be lined up alternately in opposite orientations so that they are tightly stacked.

An electronic medical record generator can generate an electronic medical record from the stored medical data. Similarly, a request generator can generate a request for at least one of a test, a study and a consultation, based on the stored medical data.

A second set of controls can include a list of common findings for at least one selected system. Normal findings can be color-coded.

Alternatively, the second set of controls can at other times include a list of possible findings or observations for a selected system. A particular part of the body image can be highlighted upon contact through the touchscreen by the user, and controls representing common observations for the selected body part can also be highlighted.

Selection of a body part from the body image through the touchscreen can be “sticky”. As a result, plural body parts can be selected and highlighted concurrently when the user sequentially touches the corresponding parts on the body image through the touchscreen.

Upon the user selecting an observation, the observation can be stored in storage. In addition, a differential diagnosis list is updated based on the observation. The differential diagnosis list can be available as a pop-up list (i.e., in a pop-up window).

The system can also include an expert system that suggests an item that the user should examine by color-coding controls associated with the item.

The body image can be an image of a whole body, or a portion of a body, such as a physiological system (nervous system, digestive system, cardiovascular system, respiratory system), an individual organ or a specific body part, e.g., an eye, a mouth or the thorax area. The portion of the body displayed can depend on a medical discipline associated with the examination. Furthermore, the invention system can initially display just a portion of a body. For example, for within an ophthalmology practice, the initial display may be of an eye.

The portion of a body displayed in the body image can also depend on a previous selection made by the user.

In one embodiment, the body image is of a human body, and can be portrayed according to any or all of gender, race and age.

A differential diagnosis list for the patient can be available as a pop-up list (pop-up window).

Similarly, a patient history of the patient can be available as a pop-up list. The patient history indicates which examinations have and have not been performed. Upon user-selection of a system of examination in the history pop-up window, a data entry screen relevant to the system of examination can be displayed. Each sentence in the history can represent one observation. Upon selection of a sentence/observation in the history pop-up window, a data entry screen used to enter that sentence/observation can be displayed. The user can, within the data entry screen, modify or delete the sentence/observation.

The system can further provide examples such as visual images or audio samples that can be used for comparison against an observation of the patient.

Suggested tests/studies can be shown in a pop-up window.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high-level schematic diagram of the present invention.

FIG. 2 is an illustration of a main data entry screen of an embodiment of the present invention.

FIG. 3 is an illustration of a thorax inspection data entry screen of an embodiment of the present invention.

FIG. 4 is an illustration of a thorax auscultation data entry screen of an embodiment of the present invention.

FIG. 5 is an illustration of a cardiovascular auscultation data entry screen of an embodiment of the present invention.

FIG. 6 is an illustration of the screen of FIG. 5, showing the highlighting of a selected body part and common observations.

FIG. 7 is an illustration of the screen of FIG. 6, showing the differential diagnosis pop-up window.

FIG. 8 is an illustration of the screens of FIG. 2, showing the history and examination pop-up window.

FIG. 9 is an illustration of the screen of FIG. 2, showing the time entry pop-up window.

FIG. 10 is an drawing illustrating the stacking of two buttons/controls of the present invention.

FIG. 11 is a simplified block diagram of an embodiment of the present invention.

### DETAILED DESCRIPTION OF THE INVENTION

A description of preferred embodiments of the invention follows.

The invention may be thought of as a tool for selecting symptoms, diagnoses, etc., from a “catalog” such as a coding system. It can be used to enter and maintain patient history, or to assist in patient examinations, or both.

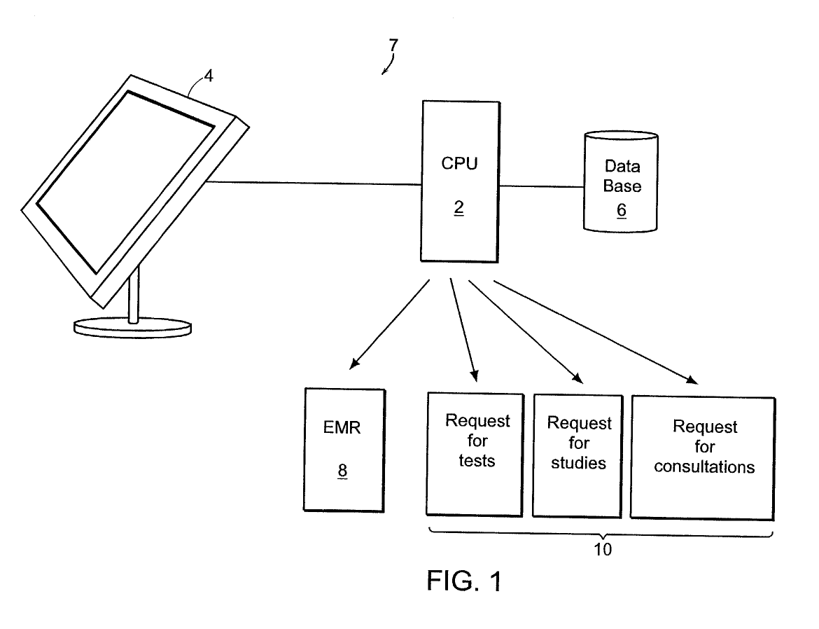

FIG. 1 is a high-level schematic diagram of the invention system 7. A computer 2 provides a graphical user interface on a touchscreen 4 and accepts input from the screen 4. Of course, more conventional methods such as using a mouse, keyboard, pen, tablet, etc., can also be used—however, it is believed that the touchscreen gives the clinician end-user the most freedom and will encourage the most use. Other devices such as personal digital assistants (PDAs) could also be used in place of the discrete computer 2 and touchscreen 4.

The processor 2 communicates with one or more databases 6 which may contain a medical code database and/or patient clinical histories.

The system 7 is used primarily to create electronic medical reports (EMRs) 8, but can also produce various requests 10, such as requests for tests, studies and/or consultations.

### EXAMPLE

The system 7 does not force the user to do things in a certain order and there are many ways of accomplishing the same task. To illustrate how the system 7 might be used, we choose one of the paths available for demonstration and walk through it step by step.

The example used is heart auscultation.

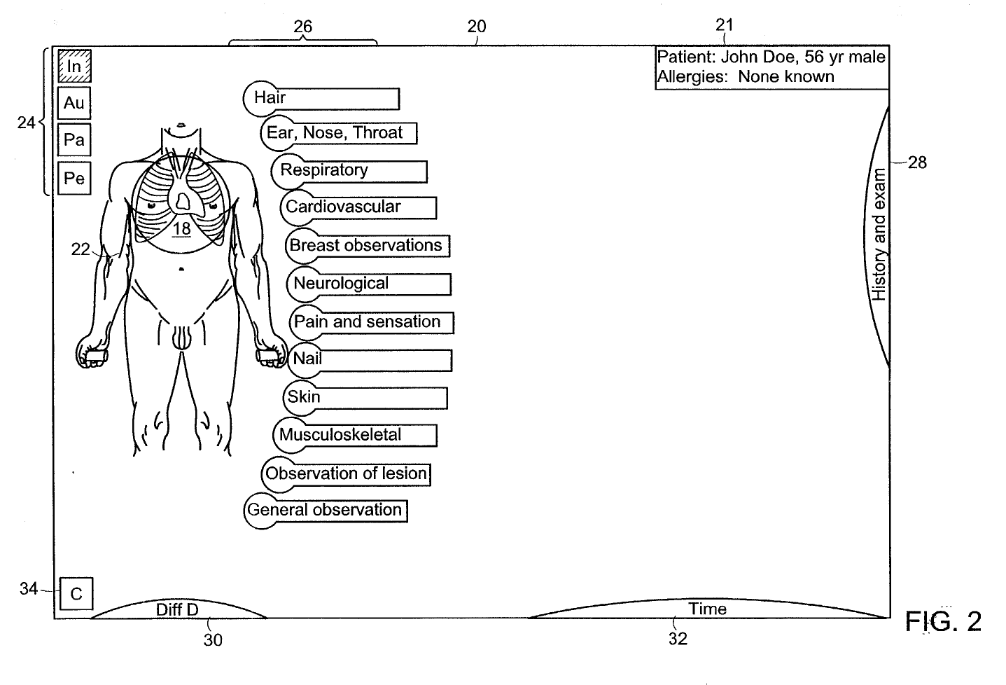

FIG. 2 is an illustration of the main data entry screen 20 depicting a whole body inspection. The patient's name, age and other personal information are presented at patient identification area 21.

The user is presented with an image 22 of the whole body as well as several buttons 26 (to the right of the body image 22) indicating major systems of observation. In particular disciplines, where a whole body image might be irrelevant, the first image presented may instead be the particular relevant portion of the body. For example, an ophthalmologist might first be presented with an image of an eye, while a dentist might first be presented with an image of a mouth.

Another set of buttons 24 indicate the four methods of examination: Inspection, Auscultation, Percussion and Palpation. Accordingly, Buttons 24 are labeled “In”, “Au”, “Pa” and “Pe”. In one embodiment, the default mode of examination is Inspection. Alternatively, the default mode is configurable according to the needs of the user. Buttons 24 may also have graphical icons (not shown).

Pop-up windows, described later, are available by selecting tab 28 for a history pop-up window, tab 30 for the differential diagnosis pop-up window and 32 for a timeline pop-up.

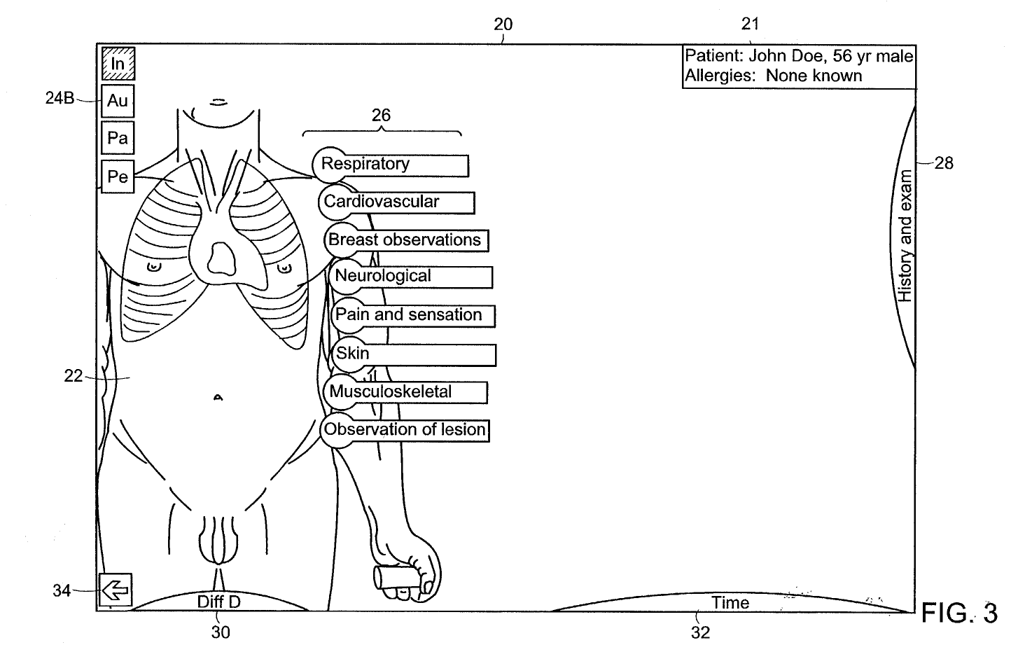

Button 34, which here bears the letter “C”, is used to close the application. In later windows (e.g., FIGS. 3-8), it turns to a left-pointing arrow and when selected, brings back the previously displayed screen.

The user may select a particular body part from the image 22. The selected body part may, for example, be a discrete part such as an arm or a leg, an area such as the lower abdomen or thorax, or an organ. Assume that the user points to the thorax region 18 of the body image 22 on the touchscreen. The image immediately zooms in to show a large image of the thorax.

FIG. 3 illustrates the resulting thorax inspection data entry screen. The first set of controls or buttons 26, to the right of the body image 22, immediately changes to reflect the area under examination. As such, buttons pertaining to systems not relevant to the thorax, such as ear-nose-throat examination, are no longer shown.

Now assume that the user decides to auscultate the thorax and presses the Auscultation button 24B.

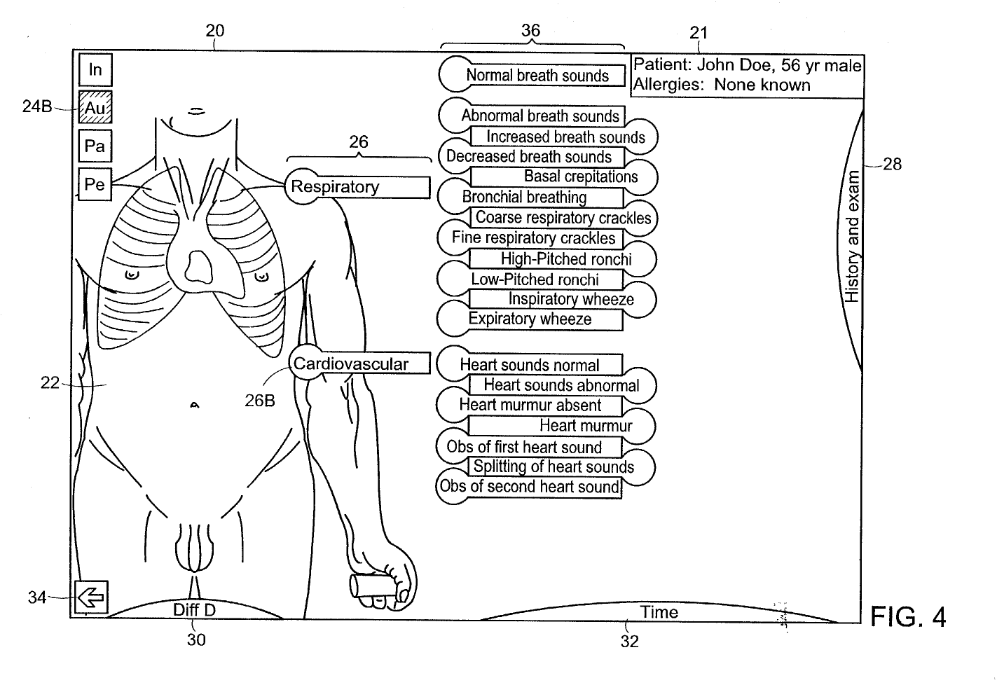

FIG. 4 illustrates the updated thorax auscultation data entry screen. The Auscultation button 24B is highlighted to indicated that an auscultation examination has been selected. The first set of buttons 26 to the right of the body image 22 immediately change to reflect this selection. That is, only buttons 26 pertaining to the cardiovascular and respiratory systems are now available, as they are the only systems available for auscultation in the thorax area.

A new set of buttons 36 is now displayed to the right of the first set of buttons 26. These buttons 36 represent the most common findings in cardiovascular and respiratory examination and can be accessed without going deeper into system of codes.

It is noted that the shape of each button 26, 36 enables efficient interleaved stacking of the buttons. As such, a fairly numerous plurality of buttons 26, 36 is displayable in the various screen views 20, in a manner that does not hinder usage (selection) of an individual button (as discussed further later).

Now, assume that the user/clinician has heard something unusual and therefore presses the cardiovascular button 26B. The screen updates so that the second set of buttons 36 now shows an extensive list of possible findings on cardiovascular auscultation.

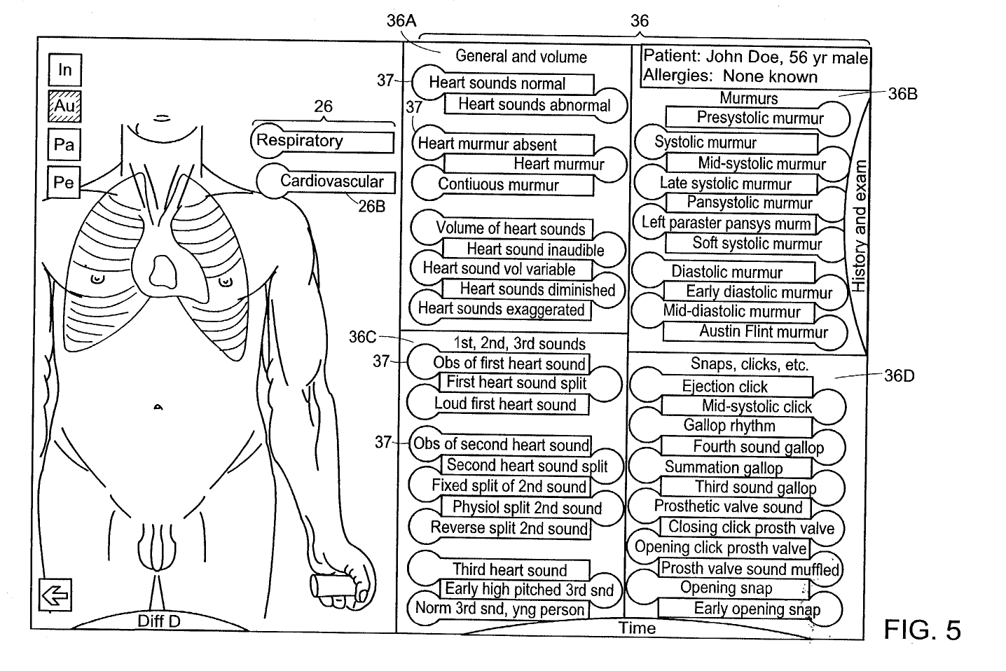

FIG. 5 illustrates a cardiovascular auscultation data entry screen. The cardiovascular button 26B, selected by the user, has been moved (repositioned) and is now highlighted. The second set of buttons 36 has been modified to contain an extensive list of possible findings. These findings are grouped in color coded segments 36A-36D. For example, in FIG. 5, these buttons are grouped into four segments, labeled “General and volume” 36A, “Murmurs” 36B, “1st, 2nd, 3rd sounds” 36C and “Snaps, clicks, etc.” 36D. The background of each of these segments can be colored with a different color.

In addition, a form of clinical decision support can also be provided. For example, observations 37 representing normal observations can have green text. Other visually highlighted or distinguishing effects are suitable.

Now assume that the user presses an image area on the thorax to the right of the sternum. This area is known as the right parasternal area and has a code in the coding system.

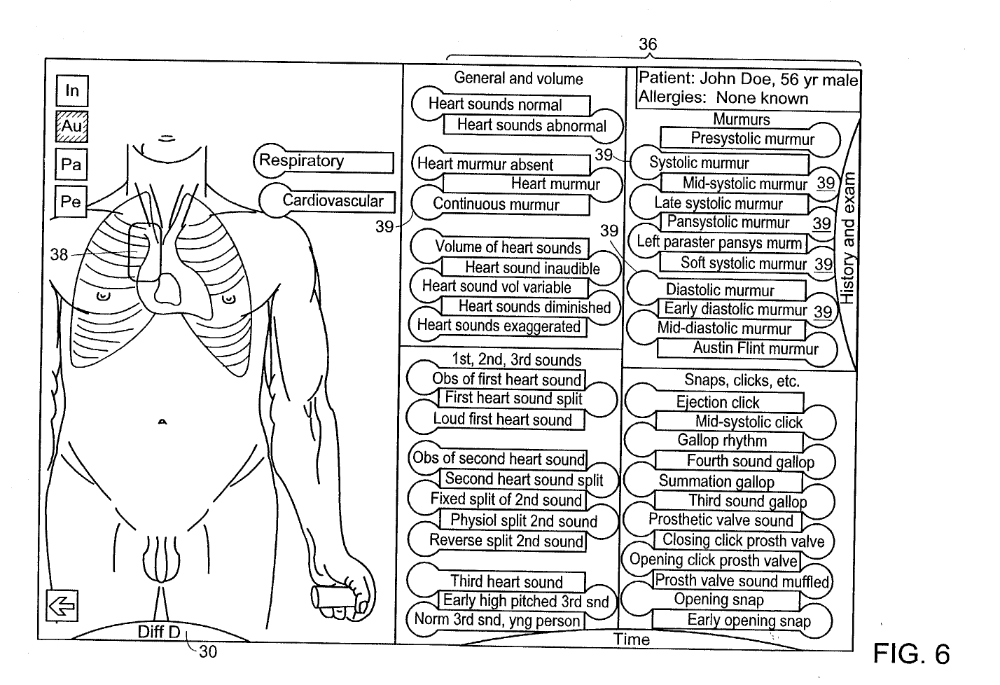

FIG. 6 illustrates the resulting screen. The selected parasternal portion 38 of the body image is highlighted, and remains highlighted. Immediately those buttons 39 in the second set 36 representing heart sounds that are particularly likely to be heard in this area are highlighted to draw the user's attention to them. Highlighting can be, for example, by filling the button with a background color such as yellow, or alternatively, by coloring the text, or by underlining, blinking, etc., the button and/or the text, or by displaying particular objects such as icons or arrows.

As seen in FIG. 6, the system 7 suggests observations, via the highlighting, without forcing them on the user (i.e., without limiting the user to use only these buttons 39). It is important to note that, although the system 7 suggests the most common observations, it does not remove or exclude the other observations, and the clinician is free to choose any of those observations. This is a very important feature of the system 7, allowing it to draw attention to and focus on a small subset of observations without restricting (limiting) the user to that subset.

Text may also indicate items that the system 7 suggests that the clinician should examine to help shorten the differential diagnosis list, for example, by coloring the text red.

Note that the selected parasternal portion 38 of the body image is highlighted, and remains highlighted, that is, the selection is “sticky.” If another body part is selected from the displayed image, both parts will be highlighted and the members that make up the set of buttons 36 will be changed to take into account both selections.

Alternatively, a user can designate an area of interest in the displayed image, for example by drawing a closed curve around the area, to select the parts of the body within the area.

Now, if the user hears a pansystolic murmer, the user can enter this observation into the underlying EMR system by pressing the button 36 labeled “pansystolic murmur.” At the same time, this information is used to update the differential diagnosis list (corresponding to Differential tab 30) to include aortic stenosis.

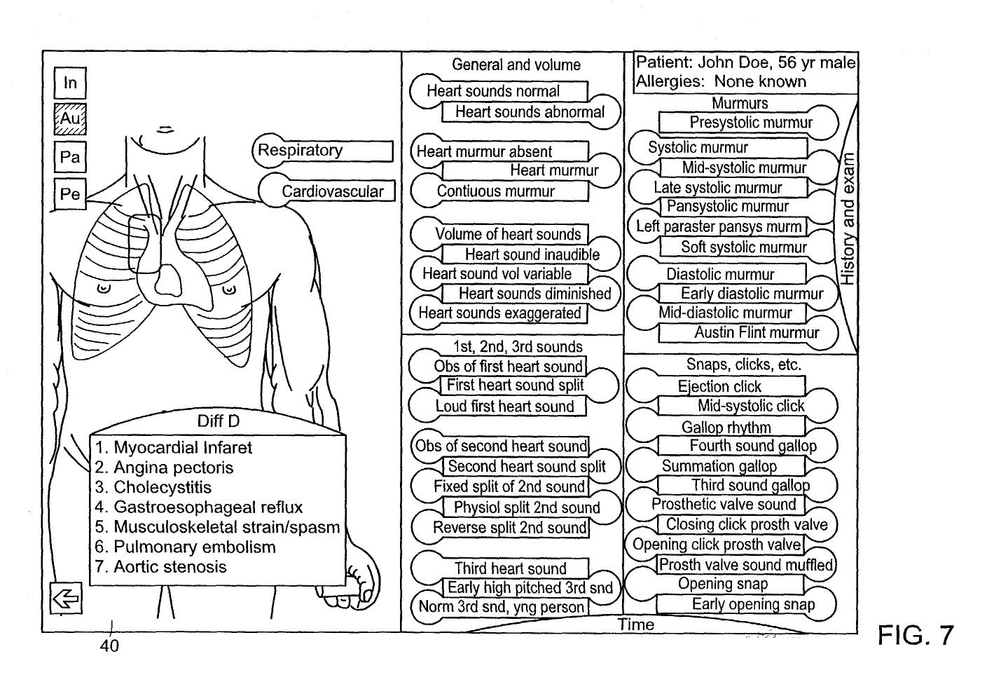

FIG. 7 illustrates the differential diagnosis list pop-up window 40, which pops up when the user selects the associated tab 30 (FIG. 6). Here, the last item in the differential diagnosis list, “7. Aortic stenosis”, was added when the pansystolic murmur button 36 was pressed in FIG. 6.

Pop-up windows for corresponding pop-up lists are available at all times. These allow the user to see what has been entered so far and also look at the differential diagnoses suggested by the system 7. Suggested tests and studies, a virtual keyboard, etc., can be implemented as such pop up windows. In a system with a sufficiently large monitor, or with multiple monitors, such windows need not be pop-up windows and could be visible at all times.

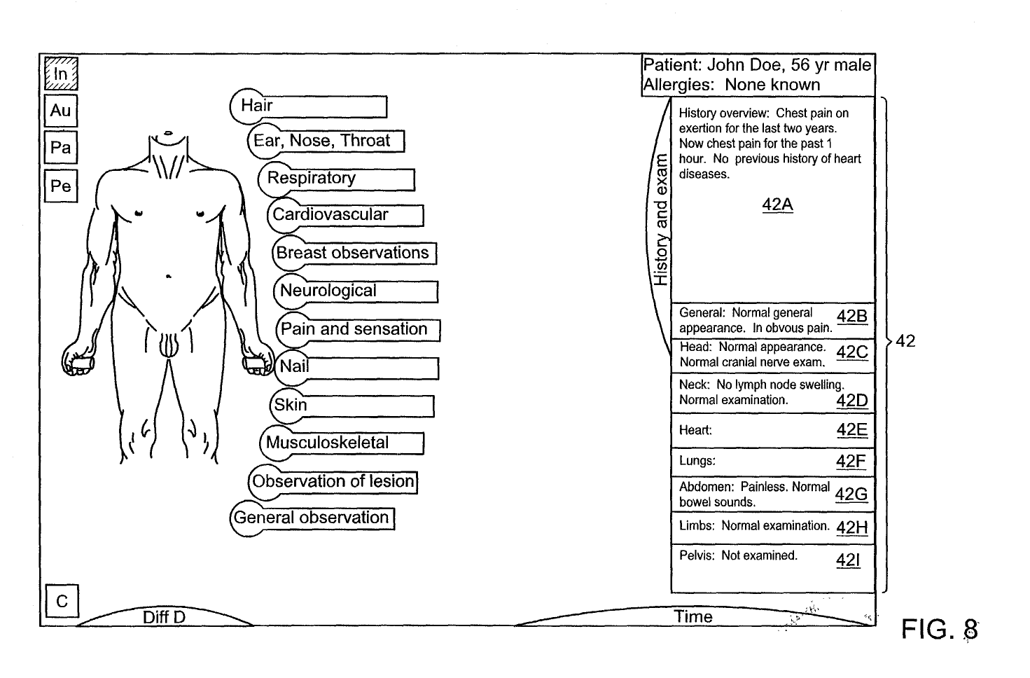

FIG. 8 additionally illustrates the History and Examination pop up window 42, which provides a clinical history of the patient. Information is presented in a series of sub-windows 42A-42I.

The information presented in the History and Examination window 42 as shown in FIG. 8 pertains to an examination. Sub-window 42A represents the history of the current illness, which must be visible for reference during a physical examination. Sub-windows 42B-42I represent different physiological systems, ordered to reflect a logical approach to a particular examination. Systems not yet examined may be highlighted. Clicking on a sub-window 42A-42I can expand that sub-window to show more information, if any is available, or can minimize the sub-window if it is currently expanded.

A similar “history” window may be divided into sections providing, for example, “history of current illness”, “history of prior illness”, “family history”, etc. Alternatively, these different sections may be implemented as separate windows.

The above example demonstrates one way of coding pansystolic murmur in the right parasternal area of a patient. Another way is to press (select) the cardiovascular button 26 in the opening screen 20 (FIG. 2), followed by the auscultation button 24B to bring the user directly to the detailed cardiovascular auscultation screen (FIG. 5). Selecting auscultation first and then the cardiovascular system button 26B would bring the user to the same part (screen view) of the system 7. There are several other ways of reaching this same screen, which illustrates how the software allows for different approaches to clinical examination.

There are three types of medical record information that can be entered: patient examination data; patient medical history; and history of a current illness. These last two comprise history data. For example, during an examination, a patient may elaborate on his or her condition by reporting to the clinician symptoms which were present in the past. This information constitutes patient history data. Patient history data is differentiated from examination data in part by the need to have temporal data associated with the history data for it to be useful.

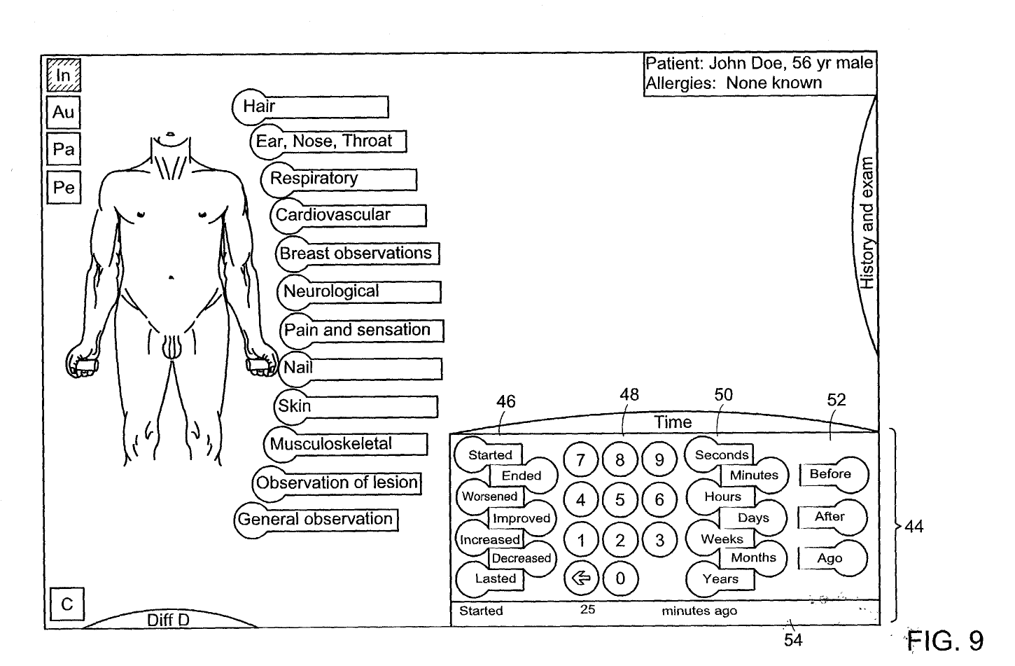

FIG. 9 illustrates a time entry dialog pop-up window 44, which appears when the corresponding time tab 32 (FIG. 2) is selected by the user. This window 44 allows temporal information for patient history data to be entered into the system via the touch screen 4. Buttons are grouped such that the clinician, by proper selection, can compose a meaningful historical description.

For example, buttons of group 46 describe how a condition has changed. Numbered buttons 48 allow the entry of multi-digit numerical values. Time unit buttons 50 describe the unit of time to be applied to the entered numerical value. Qualifier buttons 52 further help to describe when the change occurred. User selections appear in the selection indicator bar 54 below.

In this example, the user has pressed the “Started”, “2”, “5”, “minutes” and “ago” buttons in succession, resulting in the patient history “Started 25 minutes ago” as displayed in the selection indicator bar 54. While this manner of entering time data is particularly useful when using a touch screen, it may also be of value when using a mouse or any other pointing device, facilitating fast data entry.

Graphical User Interface (GUI)

MAX 7 (FIG. 1) uses a unique way of presenting clinical information on-screen. A touch screen 4 is used in novel ways to navigate through vast amounts of clinical codes and enter information into an EMR 8.

For example, the screen 4 has several subareas. The body area displays an image 22 of the human body. Buttons 36 are displayed which represent clinical codes. The uppermost part of the screen displays general patient information 21. On the borders of the screen are tabs 28, 30,32 representing pop-up windows. Selecting one of these tabs causes the associated pop-up window to be displayed, or if currently displayed, to be hidden. In one embodiment, the lower border is used to display a timeline.

In one embodiment, the body image 22 reflects the gender, race and age, and possibly other physical characteristics, of the patient. The image of the body can be zoomed for increased detail. The body image 22 is divided into areas according to rules used by clinical coding systems. Areas that can be selected change depending on the biological system being examined.

“Sticky” buttons 36 allow the image to reflect which area has been selected. Multiple areas can be selected simultaneously and an observation, such as a rash, can be tied to all of the selected locations at once (i.e., at the same time).

Clinical decision support is used to decide which observations are presented to the user, depending on the area of the body image selected. Each button 36 represents a corresponding code in the clinical coding system. In one embodiment, color coding is used for clinical support.

For example, buttons can be highlighted with a color such as yellow to indicate common findings in the area being examined. Text and/or buttons and/or button outlines can be colored green to indicate normal observations, or red to indicate items, suggested by the system 7, that the user/clinician should examine to help shorten the differential diagnosis list 40.

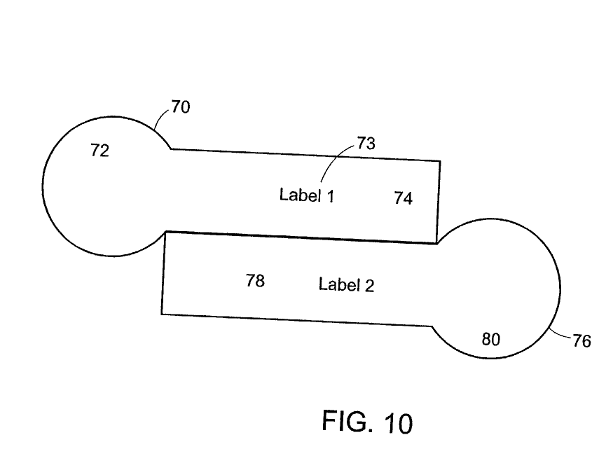

As FIG. 10 illustrates, the shape of the buttons 26, 36 is unique. A sample button 70 is illustrated, having a selection area and a description area. In this example, the selection area comprises a bubble or bulbous portion 72 at one end, and the description area comprises a narrower label portion 74 protruding from the bulbous portion 72. The label portion 74 contains a text label 73. The bulbous portion 72 makes the button suitable for touch screen use, by providing a space large enough for a user's finger to contact without contacting an adjacent button. Although the shape is circular, other bulbous shapes, such as diamonds or octagons, etc., could also be used effectively.

The bulbous portion 72 in combination with the narrower label portion 74 makes it possible to stack the buttons 70 tightly without sacrificing the ease with which users can press them with their finger. This is done by lining up (stacking) buttons in alternate orientations, for example, button 70 has its label portion 74 protruding from the right side of the bulbous portion 72, while button 76 has its label portion 78 protruding from the left side of its bulbous portion 80.

The above button design provides a solution to the limited space that is available on commonly available touchscreens. However, this limitation might very well be eliminated in the future, making buttons of other shapes equally feasible.

In another embodiment, the selection area of a button is separated from the description area, such that button selection areas are displayed on a separate window, screen or monitor from button description areas. Alternatively, individual keys on specially designed keyboards could correspond to particular areas of the display.

The clinical history and examination is displayed in an interactive pop-up window 42 (FIG. 8). This history pop-up window 42 shows which biological systems have been examined and which have not. Pressing a system of examination in a displayed history pop-up window 42 takes the user directly to the relevant data entry screen.

In addition, each sentence in each history and examination sub-window 42A-42I represents one observation. Pressing or selecting a system such as “Head” or “Neck” expands the respective sub-window 42C, 42D to show additional observations for that system. Pressing (selecting) a particular sentence or observation brings up the data entry screen that was used to enter that sentence. The user can then choose to change or delete the selected sentence/observation.

In another embodiment, this window 42 could be implemented with buttons designed such that the selection area of a button is displayed separately from the associated label, for example with a line connecting the two.

The differential diagnosis list is also displayed in a respective pop-up window 40 (FIG. 7). In similar fashion, suggested tests and studies are shown in respective pop-up windows.

In a further embodiment, samples are provided that can be used for comparison against an observation of the patient. Such samples can be for example, visual or aural. For example, a row of pictures, each showing a different type of rash can be presented on screen 4. The clinician then enters an observation by touching the displayed picture of the rash corresponding to that observed on the patient's skin. Similarly, a series of sounds can be provided for selection by the clinician user. For example, various types of murmurs may be audibly presented in this manner for selection of an observation by the clinician.

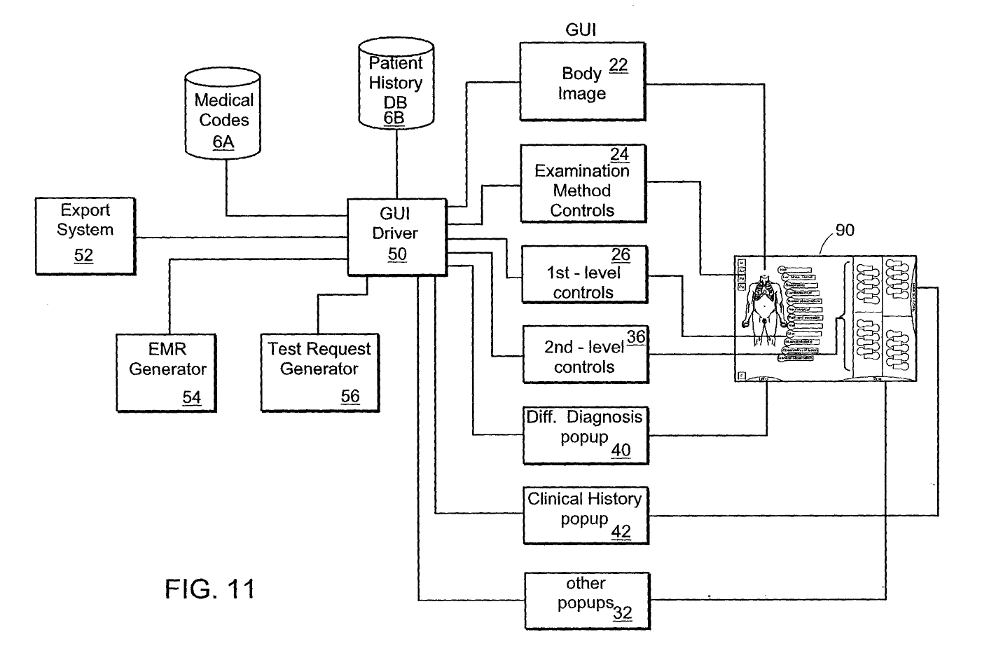

FIG. 11 is a simplified block diagram of the system 7, with reference to a sample screen 90.

A graphical user interface (GUI) driver 50 composes the screen 90 by integrating together the body image 22, examination method controls 24, first-level controls 26, second-level controls 36, a differential diagnosis pop-up window 40, a clinical history pop-up window 42 and other pop-up items 32 such as a timeline.

An expert system 52 suggests various tests or examinations to the GUI driver 50 which in response highlights certain displayed buttons.

The GUI driver 50 accesses a database 6A of medical codes and stores entered medical information from an examination into a patient history database 6B. Medical codes database 6A includes visual as well as audible selection means of corresponding medical codes.

The GUI driver 50 accesses an electronic medical record (EMR) generator 54 to generate electronic medical reports from the patient history stored in patient history database 6B. The GUI driver 50 accesses a test request generator 56 to generate requests for tests, studies and consultations, etc. based on current selections (body parts, biological systems, examination method, etc.) made by the user, as determined by expert system 52.

It should be noted that the invention is not limited to two sets of controls, as some buttons in the second set 36 (FIG. 4) may lead to a third set of controls, and so on. It is also possible that one or more buttons from the first set of controls 26 could represent codes directly. Furthermore, buttons in the second, third, etc. controls sets could represent physiological systems or even body parts or body areas.

Further embodiments of the invention may include multiple monitors. For example, one or more monitors may be used for displaying information about the patient, such as patient history or patient monitor information, e.g., heart rate, blood pressure, etc. A separate monitor would show the logical hierarchy of the system, i.e., the navigation and button/control information. Such an implementation could make one or more pop-up windows unnecessary or redundant if the separate monitors display the information that would otherwise appear in the pop-up windows.

Also, while several “pop-up” windows have been described, these windows need not be restricted to pop-up windows, appearing only when their corresponding tabs are selected. That is, the need for such windows to be “pop-up” windows is directly related to the size or number of the monitors. For example, a large monitor, or multiple monitors as described above, could display such information at all times, which may be preferable over pop-up windows.

Those of ordinary skill in the art should recognize that methods involved in a MEDICAL ADVICE EXPERT may be embodied in a computer program product that includes a computer usable medium. For example, such a computer usable medium can include a readable memory device, such as a solid state memory device, a hard drive device, a CD-ROM, a DVD-ROM, or a computer diskette, having stored computer-readable program code segments. The computer readable medium can also include a communications or transmission medium, such as a bus or a communications link, either optical, wired, or wireless, carrying program code segments as digital or analog data signals.

While this invention has been particularly shown and described with references to preferred embodiments thereof, it will be understood by those skilled in the art that various changes in form and details may be made therein without departing from the scope of the invention encompassed by the appended claims.

What is claimed is:

1. A medical advice expert system, comprising:
a graphical user interface that presents to a user coded medical information in at least one logical hierarchy, and that accepts selections of the presented information made by the user; and
an electronic medical record generator responsive to the graphical user interface and recording user selections into an electronic medical record.

2. The system of claim 1, wherein at least one logical hierarchy is organized by physiological system.

3. The system of claim 1, wherein at least one logical hierarchy is organized by type of examination.

4. The system of claim 1, wherein the graphical user interface comprises:
an image of a body, from which a user can select a body part for examination.

5. The system of claim 1, wherein the graphical user interface comprises:
examination method selection controls, from which the user can select an examination method.

6. The system of claim 1, wherein the graphical user interface comprises:
at least one set of buttons optimized for a touchscreen, each button comprising:
a selection area; and
a description area.

7. The system of claim 6,
wherein the button selection area comprises a bulbous portion large enough to be easily contacted with the user's finger without the finger contacting an adjacent button; and
wherein the button description area comprises a narrow label portion protruding from the bulbous portion and containing a text label.

8. The system of claim 7, wherein plural buttons are lined up in alternating opposite orientations so that they are tightly stacked.

9. The system of claim 6, wherein the at least one set of buttons are for indicating physiological systems of observation.

10. The system of claim 6, wherein each button of the at least one set of buttons corresponds to a medical coding system code for a medical observation and contains a descriptive label.

11. The system of claim 1, further comprising:
an expert system that makes a suggestion based on user selections.

12. The system of claim 1 wherein the suggestion is a suggested test.

13. The system of claim 1 wherein the suggestion is a suggested study.

14. The system of claim 11, wherein the suggestion is highlighted by the graphical user interface.

15. The system of claim 1, wherein user inputs are accepted from any combination of touchscreen, mouse, keyboard, pen and tablet.

16. The system of claim 1, further comprising:
a first monitor which displays patient information; and
a second monitor which displays the at least one logical hierarchy.

17. The system of claim 16, wherein displayed patient information includes patient monitor information.

18. A patient history and examination support system, comprising:
a processor;
an input device connected to the processor;
a display connected to the processor; and
a graphical user interface presented on the display which assists a user in an examination of a patient and accepts medical data entered by the user, the medical data automatically corresponding to medical coding system codes, the graphical user interface comprising
an image of a body, from which a user can select a body part for examination,
examination method selection controls, from which the user can select an examination method,
a first set of controls indicating locations to which a selected examination method can be applied, and
a second set of user selectable controls based on the selected examination method and the selected body part, each second set control corresponding to a medical coding system code for a medical observation and containing a descriptive label, user selection of a second set control being medical data entered by the user.

19. The system of claim 18, further comprising:
storage for storing codes associated with the entered medical data, the stored codes being associated with the patient.

20. The system of claim 18, wherein the body image is updated based on user selections.

21. The system of claim 18, wherein a touch-sensitive screen serves as both the display and the input device.

22. The system of claim 21, wherein the user selects a body part by touching a corresponding part of the body image displayed on the screen.

23. The system of claim 21, wherein the user selects a control by touching the control as displayed on the screen.

24. The system of claim 23, wherein a control comprises
a bulbous portion large enough to be easily contacted with the user's finger without the finger contacting an adjacent control; and
a narrow label portion protruding from the bulbous portion and containing a text label.

25. The system of claim 24, wherein plural controls are lined up alternately in opposite orientations so that they are tightly stacked.

26. The system of claim 18, further comprising an electronic medical record generator for generating an electronic medical record from the stored medical data.

27. The system of claim 18, further comprising a request generator for generating a request for at least one of a test, a study and a consultation, based on the stored medical data.

28. The system of claim 18, wherein the second set of controls comprises a list of common findings for at least one selected system.

29. The system of claim 28, wherein controls associated with normal findings are highlighted.

30. The system of claim 18, wherein the second set of controls comprises a list of possible findings for a selected system.

31. The system of claim 30, wherein a particular part of the body image is highlighted upon selection by the user, controls representing common observations for the selected body part being highlighted.

32. The system of claim 31, wherein selection of a body part from the body image is sticky, such that plural body parts are selectable and highlighted concurrently by the user sequentially selecting the corresponding parts on the body image.

33. The system of claim 30 wherein, upon the user selecting an observation, the observation is stored in the storage.

34. The system of claim 33 wherein, upon the user selecting an observation, a differential diagnosis list is updated based on the observation.

35. The system of claim 34, wherein the differential diagnosis list is provided in a separate window.

36. The system of claim 35 wherein the separate window is a pop-up list.

37. The system of claim 35, wherein the separate window is displayed in a separate monitor from the controls.

38. The system of claim 30, further comprising:
an expert system which suggests an item that the user should examine by highlighting a control associated with the item.

39. The system of claim 18, wherein the body image comprises an image of a whole body.

40. The system of claim 18, wherein the body image comprises an image of a portion of a body.

41. The system of claim 40, wherein the portion of a body displayed in the body image depends on a medical discipline associated with the examination.

42. The system of claim 41, wherein the graphical user interface initially displays the portion of a body.

43. The system of claim 40, wherein the portion of a body displayed in the body image depends on a previous selection made by the user.

44. The system of claim 18, wherein the body image is of a human body.

45. The system of claim 44, wherein the body image is according to gender.

46. The system of claim 44, wherein the body image is according to race.

47. The system of claim 44, wherein the body image is according to age.

48. The system of claim 18, wherein a differential diagnosis list for the patient is provided in a separate window.

49. The system of claim 18, further comprising a patient history window.

50. The system of claim 49, wherein the patient history window is a pop-up window.

51. The system of claim 49, wherein the patient history window is displayed in a separate monitor from the controls.

52. The system of claim 49, wherein each sentence in the patient history window represents at least one observation.

53. The system of claim 18, further comprising:
a patient examination window indicating which examinations have been performed.

54. The system of claim 53, wherein the patient examination window further indicates which examinations have not been performed.

55. The system of claim 53 wherein, upon user selection of an examination in the patient examination window, a data entry screen relevant to the examination is displayed.

56. The system of claim 49, wherein each sentence in the patient examination window represents at least one observation.

57. The system of claim 56, wherein the patient examination window includes patient history.

58. The system of claim 57 wherein, upon selection of a sentence/observation in the patient examination window, a data entry screen used to enter that sentence/observation is displayed.

59. The system of claim 58, wherein the user is provided the ability, within the data entry screen, to modify/delete the sentence/observation.

60. The system of claim 18, further comprising examples that can be used for comparison against an observation of the patient.

61. The system of claim 60, wherein the examples are visual.

62. The system of claim 60, wherein the examples are aural.

63. The system of claim 18, wherein suggested tests/studies are shown in a separate window.

64. The system of claim 63, wherein the separate window is a pop-up window.

65. The system of claim 63, wherein the separate window is displayed in a separate monitor from the controls.

66. The system of claim 18, wherein the input device comprises any combination of touchscreen, mouse, keyboard, pen and tablet.

67. A computer program product for providing a graphical user interface on a touch-sensitive screen, including program code which displays:
an image of a body, from which a user, by touching a part of the body image, can select a body part for examination;
examination method selection controls, from which the user can select an examination method;
a first set of controls indicating systems of observation to which a selected examination method can be applied; and
a second set of controls, each corresponding to a medical coding system code for a medical observation and containing a descriptive label, members of the second set of controls being based on the selected examination method and a selected body part, and for each member, upon user selection of the member, the corresponding medical coding system code being stored.

68. The computer program product of claim 67, wherein the controls of the second set of controls are highlighted to indicate and distinguish between normal observations, common observations and examinations suggested by the system.

69. The computer program product of claim 68, wherein a control is highlighted by coloring the control.

70. The computer program product of claim 68, wherein a control is highlighted by coloring its text.

71. A medical advice expert method, comprising:
using a graphical user interface, presenting to a user coded medical information in at least one logical hierarchy;
accepting selections of the presented information made by the user; and
generating an electronic medical record by recording user selections.

72. The method of claim 71, wherein at least one logical hierarchy is organized by physiological system.

73. The method of claim 71, wherein at least one logical hierarchy is organized by body part.

74. The method of claim 71, wherein at least one logical hierarchy is organized by type of examination.

75. The method of claim 71, wherein the graphical user interface comprises:
an image of a body, from which a user can select a physiological method for examination.

76. The method of claim 71, wherein the graphical user interface comprises:
examination method selection controls, from which the user can select an examination method.

77. The method of claim 71, wherein the graphical user interface comprises:
at least one set of buttons optimized for a touchscreen, each button comprising:
a selection area; and
a description area.

78. The method of claim 77,
wherein the button selection area comprises a bulbous portion large enough to be easily contacted with the user's finger without the finger contacting an adjacent button; and
wherein the button description area comprises a narrow label portion protruding from the bulbous portion and containing a text label.

79. The method of claim 78, wherein plural buttons are lined up alternately in opposite orientations so that they are tightly stacked.

80. The method of claim 77, wherein the at least one set of buttons are for indicating systems of observation.

81. The method of claim 77, wherein each button of the at least one set of buttons corresponds to a medical coding system code for a medical observation and contains a descriptive label.

82. The method of claim 71, further comprising:
making a suggestion based on user selections.

83. The method of claim 82, further comprising:
highlighting the suggestion in the graphical user interface.

84. The method of claim 82, wherein the suggestion is a suggested test.

85. The method of claim 82, wherein the suggestion is a suggested study.

86. The method of claim 71 wherein user inputs are accepted from any combination of touchscreen, mouse, keyboard, pen and tablet.

87. The method of claim 71, further comprising:
displaying patient information on a first monitor; and
displaying the at least one logical hierarchy on a second monitor.

88. The system of claim 83, wherein displayed patient information includes patient monitor information.

89. A patient history and examination support method, comprising:
presenting a graphical user interface which assists a user in an examination of a patient and accepts medical data, entered by the user, that automatically corresponds with a medical coding system code, including:
presenting an image of a body, from which a user can select a body part for examination,
presenting examination method selection controls, from which the user can select an examination method,
presenting a first set of controls indicating systems of observation to which a selected examination method can be applied, and
presenting a second set of controls based on the selected examination method and a selected body part, each second set control corresponding to a medical coding system code for a medical observation and containing a descriptive label, for each one of said second set of controls, upon user selection of the control, there being respective medical data entered.

90. The method of claim 89, further comprising:
storing codes associated with the entered medical data, the stored codes being associated with the patient.

91. The method of claim 89, further comprising:
updating the image based on user selection.

92. The method of claim 89, wherein the graphics user interface is presented on a touch-sensitive screen.

93. The method of claim 92, the user selecting a physiological method by touching a corresponding part of the body image.

94. The method of claim 92, the user selecting a control by touching the control.

95. The method of claim 94, wherein a control comprises
a bulbous portion large enough to be easily contacted with the user's finger without the finger contacting an adjacent control; and
a narrow label portion protruding from the bulbous portion and containing a text label.

96. The method of claim 95, further comprising:
lining up plural controls alternately in opposite orientations so that they are tightly stacked.

97. The method of claim 89, further comprising:
generating an electronic medical record from the stored medical data.

98. The method of claim 89, further comprising:
generating a request for at least one of a test, a study and a consultation, based on the stored medical data.

99. The method of claim 89, wherein the second set of controls comprises a list of common findings for at least one selected system.

100. The method of claim 99, further comprising:
highlighting controls associated with normal findings.

101. The method of claim 89, wherein the second set of controls comprises a list of possible findings for a selected method.

102. The method of claim 89, wherein the second set of controls comprises plural observations for a selected method.

103. The method of claim 102, further comprising:
highlighting a particular part of the body image upon contact by the user; and
highlighting controls representing common observations for the particular body part.

104. The method of claim 103, wherein selection of a body part from the body image is sticky, plural body parts being selectable and highlighted concurrently by the user sequentially touching the corresponding parts on the body image.

105. The method of claim 102 further comprising:
upon the user selecting an observation, storing the observation.

106. The method of claim 105 further comprising:
upon the user selecting an observation, updating a differential diagnosis list based on the observation.

107. The method of claim 106, wherein the differential diagnosis list is available as a separate window.

108. The method of claim 107, wherein the separate window is a pop-up window.

109. The method of claim 107, wherein the separate window is displayed in separate monitor from the controls.

110. The method of claim 102, further comprising:
suggesting an item that the user should examine by highlighting a controls associated with the item.

111. The method of claim 89, wherein the body image comprises an image of a whole body.

112. The method of claim 89, wherein the body image comprises an image of portion of a body.

113. The method of claim 112, wherein the portion of a body displayed in the body image depends on a medical discipline associated with the examination.

114. The method of claim 113, wherein the portion of a body is initially displayed.

115. The method of claim 112, wherein the portion of a body displayed in the body image depends on a previous selection made by the user.

116. The method of claim 89, wherein the body image is of a human body.

117. The method of claim 11 6, wherein the body image is according to gender.

118. The method of claim 116, wherein the body image is according to race.

119. The method of claim 116, wherein the body image is according to age.

120. The method of claim 89, wherein a differential diagnosis list for the patient is displayed in a separate window.

121. The method of claim 89, further comprising:
displaying a patient history window.

122. The method of claim 121, wherein the patient history window is a pop-up window.

123. The method of claim 121, wherein the patient history window is displayed in a separate monitor from the controls.

124. The method of claim 89, further comprising:
a patient examination window, indicating which examinations have been performed.

125. The method of claim 124, the patient examination window further indicating which examinations have not been performed.

126. The method of claim 124 further comprising:
upon selection by the user of a system of examination in the patient examination window, displaying a data entry screen relevant to the system of examination.

127. The method of claim 124, wherein the patient examination window includes patient history.

128. The method of claim 124, wherein each sentence in the patient examination window represents one observation.

129. The method of claim 128 further comprising:
upon selection of a sentence/observation in the patient examination window, displaying a data entry screen used to enter that sentence/observation.

130. The method of claim 129, further comprising:
allowing the user to modify/delete the sentence/observation within the data entry screen.

131. The method of claim 89, further comprising:
providing examples that can be used for comparison against an observation of the patient.

132. The method of claim 131, wherein the examples are visual.

133. The method of claim 131, wherein the examples are aural.

134. The method of claim 89, further comprising displaying suggested tests/studies in a separate window.

135. The method of claim 134, wherein the separate window is a pop-up window.

136. The method of claim 134, wherein the separate window is displayed on a separate monitor from the controls.

137 A medical advice expert system, comprising:
means for presenting to a user, using a graphical user interface, coded medical information in at least one logical hierarchy;
means for accepting selections of the presented information made by the user; and
means for generating an electronic medical record by recording user selections.

138. The system of claim 137, further comprising:
time entry means for entering patient history.

139. A patient history and examination support system, comprising:
means for presenting a graphical user interface which assists a user in an examination of a patient and accepts medical data, entered by the user, that automatically corresponds with a medical coding system code, said means for presenting a graphical user interface comprising:
means for presenting an image of a body, from which a user can select a physiological method for examination,
means for presenting examination method selection controls, from which the user can select an examination method,
means for presenting a first set of controls indicating methods of observation to which a selected examination method can be applied, and
means for presenting a second set of controls based on the selected examination method and a selected physiological method, each second set control corresponding to a medical coding system code for a medical observation and containing a descriptive label, for each one of said second set of controls, upon user selection of the control, there being respective medical data entered; and
means for storing codes associated with the entered medical data, the stored codes being associated with the patient.

140. A medical advice expert computer program product, the computer program product comprising a computer usable medium having computer readable code thereon, including program code which:
presents to a user, using a graphical user interface, coded medical information in at least one logical hierarchy;
accepts selections of the presented information made by the user; and
generates an electronic medical record by recording user selections.

141. A patient history and examination support computer program product, the computer program product comprising a computer usable medium having computer readable code thereon, including program code which:
presents an image of a body, from which a user can select a physiological method for examination;
presents examination method selection controls, from which the user can select an examination method;
presents a first set of controls indicating methods of observation to which a selected examination method can be applied;
presents a second set of controls based on the selected examination method and a selected physiological method, each second set control corresponding to a medical coding method code for a medical observation and containing a descriptive label; and
stores codes associated with the entered medical data.
